(19) United States
(12) Patent Application Publication
(10) Pub. No.: US 2026/0210910 A1
(43) Pub. Date: Jul. 23, 2026

(54) FIELD EMISSION SOURCE FOR ION MOBILITY SPECTROMETRY

(71) Applicant: VERILY LIFE SCIENCES LLC, South San Francisco, CA (US)

(72) Inventor: Benjamin Krasnow, San Francisco, CA (US)

(21) Appl. No.: 19/144,221

(22) PCT Filed: Jan. 2, 2024
(86) PCT No.: PCT/US2024/010027

§ 371 Date: Jun. 27, 2025

Related U.S. Application Data
(60) Provisional application No. 63/478,379, filed on Jan. 4, 2023.

(51) Int. Cl. G01N 27/622; H01J 3/02

(52) U.S. Cl. CPC G01N 27/622; H01J 3/021

(57) ABSTRACT

In one aspect, a field emission source is disclosed herein. The field emission source may include a field emission layer having at least one structure configured to emit electrons, a spacer contacting the field emission layer, and a window layer contacting the spacer and positioned opposed the at least one structure. The window layer may be transparent to electrons. Moreover, the field emission layer, the spacer, and the window layer may form an airtight cavity. In some cases, the field emission source may be used in an ion mobility spectrometer (IMS) system.

### CROSS-REFERENCES TO RELATED APPLICATIONS

The present application claims the benefit of and priority to U.S. Provisional Patent Application No. 63/478,379, filed Jan. 4, 2023, the entirety of which is hereby incorporated by reference. The present application is a national phase application of Patent Cooperation Treaty (PCT) Application No. PCT/US2024/010027, filed Jan. 2, 2024, the entirety of which is hereby incorporated by reference.

### TECHNICAL FIELD

The present disclosure relates generally to field emission systems and methods of operating and manufacturing those systems, and in particular for use with ion mobility spectrometer (IMS) systems.

### BACKGROUND

Ion mobility spectrometry (IMS) has been widely used as an effective tool for analyzing fluid samples in many technical fields. IMS systems in laboratory settings are designed to provide users with a range of options for analyzing different types of samples. Due to advantages such as detection sensitivity and selectivity, gas chromatograph (GC) IMS (GC-IMS) systems are particularly attractive as a health sensor for analyzing small quantities of biological samples containing volatile organic compounds (VOCs). As such health sensors become increasingly important in fields such as diagnostic medicine.

An important component of many IMS systems is the field emission source, which produces electrons to ionize the fluid for analysis. However, field emission sources often use radioactive materials that can be expensive, difficult to manufacture, and difficult to dispose of. Thus, there is a need for improved field emission sources that do not use radioactive materials.

The information included in this Background section of the specification, including any references cited herein and any description or discussion thereof, is included for technical reference purposes only and is not to be regarded as subject matter by which the scope of the disclosure is to be bound.

### SUMMARY

Aspects of the present disclosure include an improved field emission source. The field emission source may include a layer having one or more structures that may act as field emitters, a spacer, and a layer having an electron-transparent window. A voltage may be applied to the field emission source to cause electrons to be launched from the structures through the window. The field emission source may be used in a variety of applications, including as a part of an IMS system.

A field emission source may be provided, according to some embodiments of the present disclosure. The field emission source may include a field emission layer having at least one structure configured to emit electrons, a spacer contacting the field emission layer, and a window layer contacting the spacer and positioned opposed the at least one structure. The window layer may be transparent to electrons. The field emission layer, the spacer, and the window layer may form an airtight cavity.

In some embodiments, the cavity may be a vacuum. In some embodiments, the at least one structure may include at least one silicon microelectromechanical cone. In some embodiments, the spacer may include at least one of glass or silicon. In some embodiments, the window layer may include silicon nitride. In some embodiments, a coating may be disposed over a surface of the window layer adjacent to the cavity. In some embodiments, the coating may include a metal. The field emission source may also include a circuit electrically coupled to the field emission layer and the window layer. The circuit may be configured such that a voltage between the field emission layer and the window layer causes a voltage drop across the field emission source and a corresponding beam of electrons is emitted from the at least one structure of the field emission layer and toward the window layer. In some embodiments, a thickness of the field emission source is less than 150 nanometers.

An ion mobility spectrometer (IMS) may be provided, according to some embodiments of the present disclosure. The IMS may include an input aperture configured to receive a gas, a field emission source, and an ion guide. The field emission source may have a field emission layer comprising at least one structure configured to emit electrons, a spacer contacting the field emission layer, and a window layer contacting the spacer, where electrons are passable through the window layer. The field emission layer, the spacer, and the window layer may form a vacuum cavity. The field emission source may be configured to ionize the gas received by the ion mobility spectrometer. The ion mobility guide may have a first end and a second end, where the first end is configured to receive the ionized gas.

In some embodiments, the at least one structure may include at least one silicon microelectromechanical cone. In some embodiments, the spacer may include at least one of glass or silicon. In some embodiments, the window layer may include silicon nitride. A coating may be disposed over a surface of the window layer adjacent to the cavity. In some cases, the coating may include a metal. The IMS may also include a circuit electrically coupled to the field emission layer and the window layer. The circuit may be configured such that a voltage between the field emission layer and the window layer causes a voltage drop across the field emission source and a corresponding beam of electrons is emitted from the at least one structure of the field emission layer towards the window layer. In some embodiments, a thickness of the field emission source may be less than 150 nanometers.

A field emission source may be provided, according to some embodiments of the present disclosure. The field emission source may include a field emission layer, at least one structure configured to emit electrons, a window layer comprising a window that is transparent to electrons, and a spacer having a first side and a second side. The first side of the spacer may be bonded to the field emission layer and the second side of the spacer may be bonded to the window layer such that the field emission layer, spacer, and window form a vacuum-sealed cavity encompassing the at least one structure.

In some embodiments, the at least one structure may include at least one silicon microelectromechanical cone. In some embodiments, the field emission source may include a circuit electrically coupled to the field emission layer and the window layer. The circuit may be configured such that a voltage between the field emission layer and the window layer causes a voltage drop across the field emission source and a corresponding beam of electrons is emitted from the at least one structure and in a direction of the window layer.

Additional aspects, features, and advantages of the present disclosure will become apparent from the following detailed description.

### BRIEF DESCRIPTION OF THE DRAWINGS

Illustrative embodiments of the present disclosure will be described with reference to the accompanying drawings, of which:

FIG. 1 is a schematic diagram of a GC-IMS system, according to some embodiments of the present invention.

FIG. 2 is an exploded view of a field emission source, according to some aspects of the present disclosure.

FIG. 3 is a cross-section of a field emission source, according to some embodiments of the present disclosure.

FIG. 4 is a flowchart of a method of manufacturing a field emission source, according to some embodiments of the present disclosure.

### DETAILED DESCRIPTION

The following description is provided for exemplary purposes only and should not be considered to limit the scope of the invention. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. The examples described herein are provided for purposes of illustration and thus not intended to be limiting.

In accordance with at least one embodiment of the present invention, an improved field emission source may be provided. The field emission source may include a field emission layer, a spacer, and a window layer that are bonded together. There may be an airtight cavity within the field emission source, which may, in some cases, be a vacuum. The field emission layer may include one or more structures that extend into the cavity. When a voltage is applied to the field emission source, the electric field may be concentrated within the structures such that electrons are launched or propagated off the tips of the structures. There may be a window in the window layer that is transparent to electrons such that the electrons launched from the structures may pass across the cavity, through the window, and out of the field emission source.

Field emission sources according to at least some embodiments described herein may have several benefits. The field emission sources may not use radioactive materials which can be difficult to manufacture and dispose of and thus may be more expensive. Moreover, the field emission source is simple to manufacture and a large number of field emission sources can be fabricated simultaneously. Additionally, the field emission source may be generally planar and may be small relative to other field emission sources.

Field electron sources described herein can be used in several different applications. For example, some embodiments of the field electron source may be included in an ion mobility spectrometer (IMS) system. IMS systems identify unknown compounds by analyzing the time it takes for different ionized molecules to move from one end of a drift region to the other end. Different compounds will travel at different rates through the ion guide because the compounds have different masses, thus, the rate at which molecules move through the drift region can be used to identify the molecules in the sample. One or more embodiments of a field electron source described herein can be used in an IMS system to generate electrons that can ionize the gaseous sample before it enters the drift region.

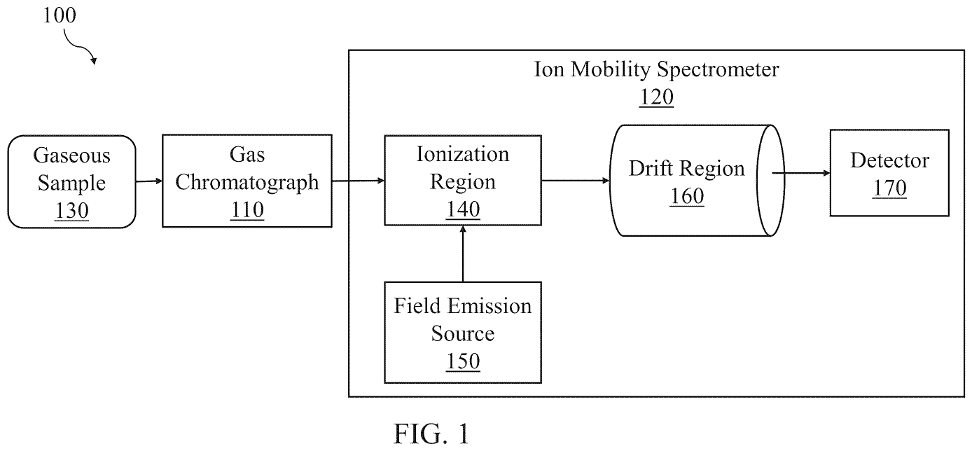

FIG. 1 illustrates schematic diagram of a GC-IMS system 100 according to some embodiments of the present invention. The GC-IMS system 100 includes a gas chromatograph (GC) system 110 and an IMS system 120. The GC system 110 may receive and modify a gaseous sample 130. The modified sample may then be output from the GC system 110 and input into the ionization region 140 of the IMS system 120. A field emission source 150 may be coupled to the ionization region 140 such that the field emission source 150 emits electrons into the ionization region 140. In the ionization region 140, the electrons may contact and ionize the molecules in the modified sample. The ionized molecules in the modified sample may then pass into the drift region 160. The drift region 160 may have any appropriate structure. For example, the drift region 160 may include an ion guide. An electric field is applied in the drift region 160 that acts upon the ionized molecules in the modified sample, resulting in propagation of the ionized molecules from a first end of the drift region 160 to a second end. A detector 170 may be disposed at the second end of the drift region 160 to receive the ionized molecules. Different ionized molecules in the modified sample may travel through the electric field at different rates depending on their mass. Thus, the detector 170 can measure the time it takes each molecule to travel from the first end to the second end and determine the mass of the different molecules therefrom. In this way, the detector 170 can provide an indication of the composition of the gaseous sample 130. In some embodiments, the detector 170 may include or be coupled to a microprocessor that can analyze the measurements to estimate the composition of the gaseous sample 130.

The preceding and following description pertains to an improved GC-IMS system 100 and, in particular, an improved field emission source for use in a GC-IMS system 100. However, it is contemplated that the invention described herein can be used for other applications, including other IMS systems 120 or any other application that requires electron emissions.

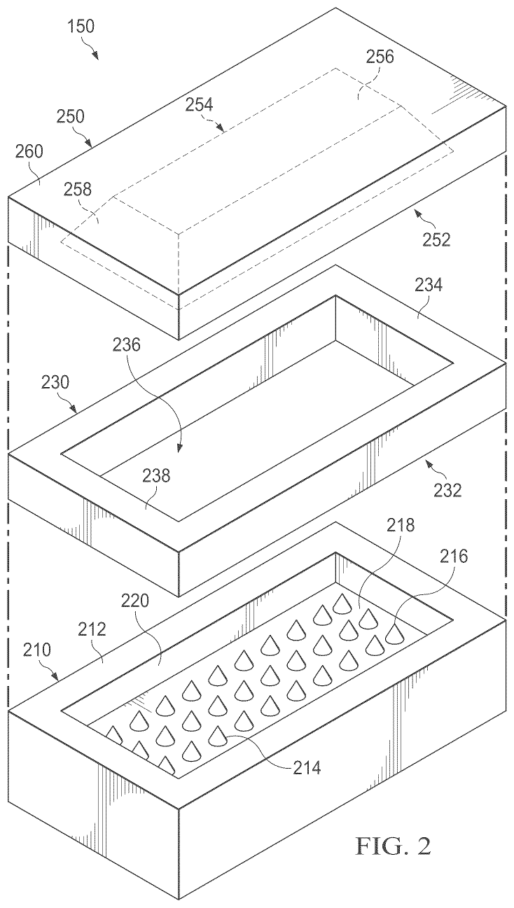

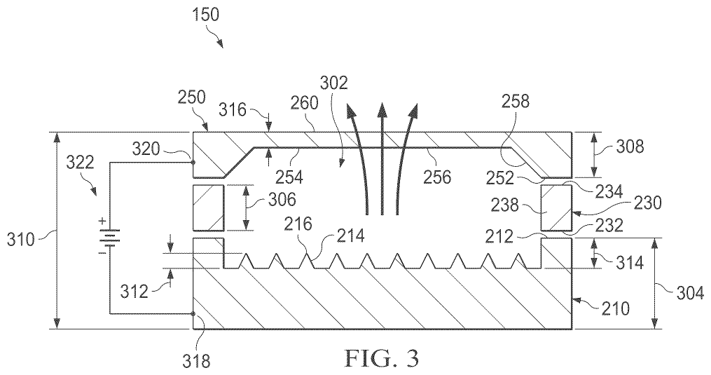

FIG. 2 illustrates an exploded view of a field emission source 150 according to some aspects of the present disclosure. The field emission source 150 may comprise three layers: a field emission layer 210, a spacer 230, and a window layer 250. The field emission layer 210 may be the bottom layer of the field emission source 150 and the window layer 250 may be the top layer. The spacer 230 may form the middle layer. Thus, the bottom 232 of the spacer 230 may be coupled or bonded to the top 212 of the field emission layer 210, and the bottom 252 of the window layer 250 may be coupled to the top 234 of the spacer 230. In some embodiments, the spacer 230 has an opening 236 extending from the bottom 232 to the top 234 such that the opening 236 is defined by the sides 238 of the spacer. The field emission layer 210, the spacer 230, and the window layer 250 may be coupled such that the opening 236 forms a cavity in the field emission source 150 (as shown in FIG. 3 and described in more detail below in reference thereto). As would be understood, the terms “top,” “bottom,” and “middle,” are used for convenience relative to the orientation of the field emission source 150 shown in FIG. 2. In an embodiment, the field emission source 150 may be oriented so that the top layer 250 is closest to the location where a source of electrons is needed, such as the ionization region 140 in FIG. 1.

The field emission layer 210 is a layer of one or more materials and structures 214 extending from a top 212 surface. The structures 214 may be any appropriate shape as was known for field emitter arrays, including, for example, cones, cylinders, pyramids, cylinders including a taper or cone at the top. In some embodiments, the tip 216 of the structures 214 may be pointed or sharp. In some embodiments, the structures 214 may be microelectromechanical systems (MEMS) or nanoelectromechanical systems (NEMS). For example, the structures 214 may be MEMS cones or pyramids.

In some embodiments, the structures 214 may be disposed on the top surface 212 of the field emission layer 210. The structures 214 may be dispersed uniformly or nonuniformly on an area of the top surface 212. In some embodiments, each of the structures may be spaced from the edges of the top surface 212 such that there is an empty portion along the perimeter with no structures 214. In some embodiments, there may be a base 218 that is sunken with respect to the top surface 212 of the field emission layer 210. There may be sides 220 around the base 218 that connect the base 218 to the top surface 212. The sides 220 may taper outward or inward from the base 218 to the top surface 212. In some embodiments, the sides 258 are perpendicular to the base 218 and the top surface 212. In some embodiments, structures 214 may extend from the base 218 upward towards the top surface 212. The base 218 may be any appropriate shape. For example, the base 218 may be a rectangle, square, circle, oval, triangle, pentagon, or any other appropriate shape.

The window layer 250 may be a layer of one or more materials that includes a relatively thin layer of material referred to herein as window 254. The window 254 may be a divot or cutout formed in the bottom surface 252 of the window layer 250. The window 254 may include a base 256 that is sunken with respect to the bottom surface 252 such that the base 256 is located between the bottom 252 and top 260 surfaces of the window layer 250. The sides 258 of the window 254 may taper outward from the base 256 to the bottom surface 252 of the window layer 250, as shown in the illustrated embodiment. In some embodiments, the sides 258 taper inward, are perpendicular to the base 256 and the bottom surface 252, are curved or have any appropriate shape. The base 256 may be any appropriate shape. For example, the base 256 may be a rectangle, square, circle, oval, triangle, pentagon, or any other appropriate shape.

The layers 210, 230, 250 may be generally planar and, thus, the assembled field emission source 150 may also be generally planar. In some embodiments, the length of the field emission source 150 may be larger than the height of the field emission source 150.

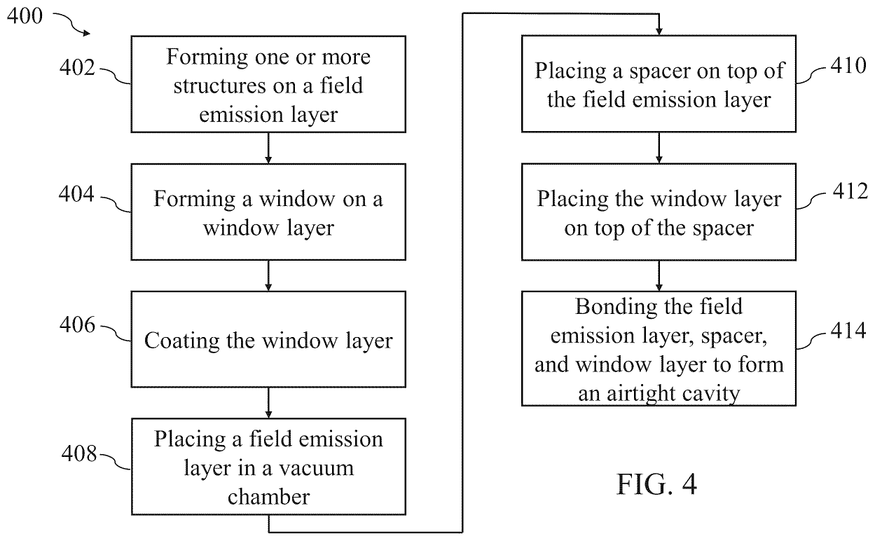

FIG. 3 illustrates a cross-section of the field emission source 150 in FIG. 2, according to some embodiments of the present disclosure. In some embodiments, the top 212 of the field emission layer 210 is coupled to the bottom 232 of the spacer 230 and the top 234 of the spacer 230 is coupled to the bottom 252 of the window layer 250. The layers 210, 230, 250 may be coupled in any appropriate way. For example, the layers may be coupled by bonding, with an adhesive, with a mechanical coupling mechanism, or in any other appropriate way, as described in more detail below in reference to FIG. 4.

The field emission layer 210, the spacer 230, and window layer 250 may be coupled such that a cavity 302 is formed by the opening 236 of the spacer 230 and surrounded by the sides 238 of the spacer 230, the field emission layer 210, and the window layer 230. The opening 236 may be sized and shaped such that the sides 238 defining the opening 236 surround the one or more structures 214 on the field emission layer 210. The sides 238 of the spacer 230 are disposed around the structures 214. In some embodiments, the thickness 306 of the spacer 230 is larger than the thickness 312 of the structures 214. The layers 210, 230, 250 may be sealed such that the cavity 302 is airtight. In some embodiments, the cavity may be vacuum sealed such that the cavity 302 is a vacuum.

The layers 210, 230, 250 may have any appropriate thickness. In some embodiments, the height 304 of the field emission layer 210 is in a range of 0.5 millimeters (mm) to 1 mm. For example, in some embodiments, the field emission layer 210 may be 1 mm. In some embodiments, the thickness 306 of the spacer 230 is in a range of 1 mm to 3 mm. For example, in some embodiments, the thickness 306 of the spacer may be approximately 2 mm. In some embodiments, the thickness 308 of the window layer 250 may be in a range of 0.25 mm to 1 mm. For example, in some embodiments, the thickness 308 of the window layer 250 is 0.5 mm, a common thickness of silicon wafer used to produce these parts. Thus, the overall thickness 310 of the field emission source 150 may be in a range of 0.75 mm to 5 mm. For example, in some embodiments, the overall thickness 310 may be 3 mm.

Additionally, the structures 214 have a length 312. In some embodiments in which the structures 214 extend from the top surface 212 of the field emission layer 210, the structures 214 extend a distance 312 above the top surface 212. In embodiments in which the field emission layer 210 includes a base 218 that is sunken with respect to the top surface 212 (as in the illustrated embodiment), one or more structures 214 may have a length 312 and the sides 220 surrounding the base 218 may have a height 314. In some embodiments, one or more structures 214 may have a length 312 greater than the height 314 of the sides 220 such that the structures 214 extend past the top surface 212 and into the opening 236 formed in the spacer 230. In some embodiments, one or more structures 214 may have a length 312 less than the height 314 of the sides 220 such that the structures 214 do not extend past the top surface 212. In some embodiments, one or more structures 214 may have a length 312 that is equal to the height 314 of the sides 220 such that the structures extend to the same level as the top surface 212. The one or more structures may have any combination of heights 312. In some cases, the structures 214 may all have the same height or, in other cases, the structures 214 may have different heights 312.

The window 254 may have a thickness 316 measured from the base 256 of the window 254 to the top surface 260 of the window layer 250. In some embodiments, the window 254 may include a thin layer of material such that the window 254 is transparent to electrons. In some cases, the window 254 may be transparent to electrons but not transparent to air. Thus, the thickness 316 may be in the range of 50 nanometers (nm) to 150 nm. For example, the thickness 316 of the window 254 may be 100 nm. The field emission source 150 may also be termed or understood as a field emitter array.

The field emission layer 210 may include any appropriate material used in field emitter arrays, such as doped silicon. The structures 214 may also comprise a conductive material. The structures 214 may comprise the same material or a different material than the rest of the field emission layer 210. For example, the structures 214 may be metal, doped silicon or carbonized cork. The spacer 230 may also comprise any appropriate material, such as glass, quartz, or silicon.

The window layer 250 may comprise any appropriate material, such as silicon nitride, silicon, or copper. In particular, the window 254 may comprise any material that electrons can pass through. For example, the window 254 may comprise nitride or silicon nitride. In some embodiments, there may be a coating applied to the surface of the window 254 such that the coating faces the cavity 302. In some embodiments, the coating may be thin enough so that electrons can pass through the coating and the window 254. For example, the thickness of the coating may be in a range of 0.5 nm to 30 nm. In some cases, the thickness of the coating may be 1 nm. The coating may be added to provide a conductive layer over the window 254. In some embodiments, the window 254 may not be conductive, so a coating may be used so that electricity can pass along the window 254, as described in more detail below.

A circuit 322 may be coupled to the field emission source 150. There may be a first electrode 318 coupled to the field emission layer 210 and a second electrode 320 coupled to the window layer 250. The field emission layer 210 may include a conductive material such that electricity may be conducted across the layer 210. One or more structures 214 may also include a conductive material so that a current can pass through the field emission layer 210 and through one or more structures 214. Moreover, the window layer 250 may include a conductive material so that electricity can pass through the window layer 250 as well. The window 254 may include a conductive material as well so that electricity can pass through the window 254. There may also be a conductive coating on the window 254 such that electricity can pass through the coating and/or the window 254.

A voltage may be applied to the field emission layer 210 and the window layer 250 such that a voltage drop occurs across the field emission source 150. The applied voltage may cause a beam of electrons to be emitted from one or more structures 214 of the field emission layer 210. The tips 216 of the structures 214 may be sharp or pointed so that an electric field is concentrated in the structures 214 and the electrons can be launched or propelled off the tip 216 and across the cavity 302 towards the window layer 250. Because the window 254 may be transparent to electrons, the electrons launched from the structures 214 may pass through the window 254 and out of the field emission source 150. As described above with reference to FIG. 1, in some embodiments, the field emission source 150 may be used in an IMS system 120. Thus, the field emission source 150 may emit electrons such that the electrons may pass through the window 254 of the field emission source 150 to the ionization region 140 of the IMS system 120, so that the electrons can ionize molecules in a gaseous sample.

Any appropriate voltage may be applied to the field emission source 150. For example, the circuit 322 may apply a voltage in a range of 10 kilovolts (kV) to 15 kV. The current produced may be any appropriate value. For example, the current may be in a range of 1 microamps (μA) to 150 μA. Thus, in some embodiments, a 12 kV voltage may be applied to the field emission source 150 to produce a current of 100 μA.

The emission from the field emission source 150 can be controlled in a variety of ways. The distance between the structures 214 and the window 254 may impact the amount and/or speed of electrons emitted from the field emission source 150. Moreover, the amount of voltage applied to the field emission source 150 may also impact the amount and/or speed of electrons emitted from the field emission source 150. Thus, the distance between the structures 214 and the window 254 or the voltage applied may be chosen to produce a desired beam of electrons.

FIG. 4 depicts a flowchart illustrating a method 400 of manufacturing a field emission source 150, according to some embodiments of the present disclosure. Method 400 is merely an example and is not intended to limit the present disclosure beyond what is explicitly recited in the claims. Additional operations can be provided before, during, and after method 400, and some operations described can be replaced, eliminated, or moved around for additional embodiments of the method.

Step 402 may include forming one or more structures 214 on a field emission layer 210. In some embodiments, a doped silicon wafer provides the material on which the emitters are formed by a masking and etching process. The silicon of the field emission layer 210 may then be patterned and etched away, leaving one or more structures 214. As described above, the structures 214 may be any appropriate shape or size. Although silicon is described, this is only an example and any other appropriate materials may be used during the etching process. Moreover, any other appropriate process for forming the structures 214 may be used. For example, carbonized cork may be introduced as a material for a field emitter. As is known, light natural cork becomes a graphitic honeycomb upon carbonization. In some cases, the structures 214 may be formed via lithography or any other process for fabricating an array of emitters.

Step 404 may include forming a window 254 on a window layer 250. In some embodiments, the window layer 250 may comprise silicon nitride and may have a layer of silicon and a layer of nitride. Starting with a layer of silicon, a layer of nitride may be applied. Then part of the silicon layer may be etched away, leaving the nitride layer. The etching process may form a window of any desired shape and size. Moreover, the layer of nitride may be any appropriate thickness. As described above, the nitride layer be in a range of 50 to 150 nm so that the window 254 is thin enough to be transparent to electrons. Although silicon and nitride are described, this is only an example and any other appropriate materials may be used during the etching process. Moreover, any other appropriate process for forming the window 254 may be used. In some cases, the window 254 may be formed via lithography.

Step 406 may include coating the window layer 250. The window layer 250 may optionally be coated with a conductive material. The conductive material may be applied to the bottom surface 252 of the window layer 250 and may cover the window 254. The coating may only cover the window 254, may cover both the window 254 and the window layer 250, or may cover part or all of the window 254 and/or part or all of the window layer 250. As described above, the coating may be conductive such that electricity may be conducted across the window layer 250 and/or the window 254. The window layer 250 may be coated in any appropriate way. For example, the coating may be applied via a deposition process such as atomic layer deposition or vapor deposition.

Step 408 of method 400 includes placing a field emission layer 210 in a vacuum chamber. In some embodiments, the field emission source 150 may be formed in a vacuum chamber so that the cavity 302 formed in the field emission source 150 may be a vacuum. However, in other embodiments, the cavity 302 may not be a vacuum and may instead be at atmospheric pressure or may be at a higher pressure.

Step 410 includes placing a spacer 230 on top of the field emission layer 210. The spacer 230 may be placed on the top surface 212 of the field emission layer 210 such that part or all of the bottom surface 232 of the spacer 230 may directly contact part or all of the top surface 212 of the field emission layer 210. The spacer 230 may be placed such that the opening 236 is above the one or more structures 214 on the field emission layer 210 and the structures 214 are surrounded by the sides 238 of the spacer 230. In some cases, one or more structures 214 may not be covered by the sides 238 of the spacer 230 when it is placed on top of the field emission layer 210. In some embodiments, one or more structures 214 may extend into the opening 236 of the spacer 230.

Step 412 includes placing a window layer 250 on top of the spacer 230. The window layer 250 may be placed on the top 234 of the spacer 230 such that the window 254 is disposed above and faces the opening 236 of the spacer 230. Part or all of the top surface 234 of the spacer 230 may contact part or all of the bottom surface 252 of the window layer 250. The field emission layer 210, spacer 230, and window layer 250 may be placed such that they form a cavity 302. The cavity 302 may be fully enclosed by the layers 210, 230, 250.

Step 414 includes bonding the field emission layer 210, spacer 230, and window layer 250 to form an airtight cavity 302. In some embodiments, the layers 210, 230, 250 may be anodically bonded. The spacer 230 may comprise glass, which may be boron-doped glass, or silicon. The field emission layer 210 and the window layer 250 may comprise silicon or silicon nitride. However, these materials are only examples and any appropriate materials may be used for the spacer 230, field emission layer 210, and the window layer 250. The vacuum chamber may be sealed and a vacuum may be formed in the chamber. The chamber may be heated and an electric field may be propagated through the chamber such that the spacer 230 bonds to each of the field emission layer 210 and the window layer 250. The chamber may then be unsealed and the completed field emission source 150 may be removed.

The method 400 may be used to fabricate one or more field emission sources 150 at once. For example, 1 to 200 field emission sources may be fabricated in one batch.

In other embodiments, the layers 210, 230, 250 may be coupled by any appropriate method. For example, the layers 210, 230, 250 may be coupled together via an adhesive layer. In other examples, the field emission source 150 may be fabricated by additive manufacturing or injection molding.

Persons skilled in the art will recognize that the devices, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A field emission source comprising:
a field emission layer comprising at least one structure configured to emit electrons;
a spacer contacting the field emission layer; and
a window layer contacting the spacer and positioned opposed the at least one structure, wherein the window layer is transparent to electrons,
wherein the field emission layer, the spacer, and the window layer form an airtight cavity.

2. The field emission source of claim 1, wherein the cavity is a vacuum.

3. The field emission source of claim 1, wherein the at least one structure comprises at least one silicon microelectromechanical cone.

4. The field emission source of claim 1, wherein the spacer comprises at least one of glass or silicon.

5. The field emission source of claim 1, wherein the window layer comprises silicon nitride.

6. The field emission source of claim 1, further comprising a coating disposed over a surface of the window layer adjacent to the cavity.

7. The field emission source of claim 6, wherein the coating comprises a metal.

8. The field emission source of claim 1, further comprising a circuit electrically coupled to the field emission layer and the window layer, wherein the circuit is configured such that a voltage between the field emission layer and the window layer causes a voltage drop across the field emission source and a corresponding beam of electrons is emitted from the at least one structure of the field emission layer and toward the window layer.

9. The field emission source of claim 1, wherein a thickness of the field emission source is less than 150 nanometers.

10. An ion mobility spectrometer comprising:
an input aperture configured to receive a gas;
a field emission source comprising:
a field emission layer comprising at least one structure configured to emit electrons;
a spacer contacting the field emission layer; and
a window layer contacting the spacer, wherein electrons are passable through the window layer,
wherein the field emission layer, the spacer, and the window layer form a vacuum cavity, and
wherein the field emission source is configured to ionize the gas; and
an ion guide comprising a first end and a second end, the first end being configured to receive the ionized gas.

11. The ion mobility spectrometer of claim 10, wherein the at least one structure comprises at least one silicon microelectromechanical cone.

12. The ion mobility spectrometer of claim 10, wherein the spacer comprises at least one of glass or silicon.

13. The ion mobility spectrometer of claim 10, wherein the window layer comprises silicon nitride.

14. The ion mobility spectrometer of claim 10, further comprising a coating disposed over a surface of the window layer adjacent to the cavity.

15. The ion mobility spectrometer of claim 14, wherein the coating comprises a metal.

16. The ion mobility spectrometer of claim 10, further comprising a circuit electrically coupled to the field emission layer and the window layer, wherein the circuit is configured such that a voltage between the field emission layer and the window layer causes a voltage drop across the field emission source and a corresponding beam of electrons is emitted from the at least one structure of the field emission layer towards the window layer.

17. The ion mobility spectrometer of claim 10, wherein a thickness of the field emission source is less than 150 nanometers.

18. A field emission source comprising:
a field emission layer;
at least one structure configured to emit electrons;
a first layer comprising a window, wherein the window is transparent to electrons; and
a spacer having a first side and a second side, wherein the first side is bonded to the field emission layer and the second side is bonded to the first layer such that the field emission layer, spacer, and window form a vacuum-sealed cavity encompassing the at least one structure.

19. The field emission source of claim 18, wherein the at least one structure comprises at least one silicon microelectromechanical cone.

20. The field emission source of claim 18, further comprising a circuit electrically coupled to the field emission layer and the first layer, wherein the circuit is configured such that a voltage between the field emission layer and the first layer causes a voltage drop across the field emission source and a corresponding beam of electrons is emitted from the at least one structure and in a direction of the first layer.
